(19) United States
(12) Patent Application Publication
(10) Pub. No.: US 2002/0083954 A1
(43) Pub. Date: Jul. 4, 2002

(54) Cosmetic system

(76) Inventor: James A. Gavney JR., Palo Alto, CA (US)

Correspondence Address: James A. Gavney Jr., HAVERSTOCK & OWENS LLP, Suite 420, 260 Sheridan Avenue, Palo Alto, CA, 94306, US

(21) Appl. No.: 10/026,598

(22) Filed: Dec. 24, 2001

Related U.S. Application Data
(60) Provisional application No. 60/258,723, filed on Dec. 28, 2000.

(51) Int. Cl. B26B 13/22; A45D 29/18

(52) U.S. Cl. 132/297; 132/73.5

(57) ABSTRACT

The cosmetic system of the current invention preferably has a dispenser for dispensing a solid or semi-sold cosmetic and an applicator for applying a liquid or semi-liquid cosmetic. The dispenser and the applicator are preferably coupled through a cap portion configured for capping a container holding the liquid or semi-liquid cosmetic. The liquid or sem-liquid cosmetic can be nail polish and the solid or semi-solid cosmetic can be lipstick. The system is preferably configured such the dispenser serves a handle for applying the liquid or sem-liquid cosmetic with the applicator and the container serves as a handle for dispensing or applying the solid or semi-sold cosmetic from the dispenser. According to an embodiment of the invention, the dispenser and the applicator are configured to be detachably coupled and are marked with an identification means to match the dispenser with the applicator once they are separated.

### RELATED APPLICATION(S)

This Patent Application claims priority under 35 U.S.C. 119 (e) of the co-pending U.S. Provisional Patent Application Serial No. 60/258,723, filed Dec. 28, 2000, and entitled “COSMETIC SYSTEM”. The Provisional Patent Application, Serial No. 60/258,723, filed Dec. 28, 2000, and entitled “COSMETIC SYSTEM” is also hereby incorporated by reference.

### FIELD OF THE INVENTION

This invention relates generally to cosmetic systems. In particular this invention relates cosmetic systems with more than one cosmetic product.

### BACKGROUND

There are numerous types of packaging for cosmetics. Cosmetic packaging is often used to hold a cosmetic as well as dispense or apply the cosmetic to the user's body, face or hair. Cosmetic packaging is often fashionable and intended to give aesthetic value as well as functional value to the cosmetic product.

Choosing cosmetic products can be difficult for several reasons. Cosmetic products need to be matched with the user's complexion, hair color and/or desired effect. Further, cosmetic products are preferable matched or color coordinated with each other. It is often difficult to match different types of cosmetic products even within the same manufacturer or brand name. Additionally, different types of cosmetic products are typically sold separately, packaged individually and the user is requires to store and manage their own inventory of each cosmetic product.

Therefore, there is a need for a cosmetic packaging system which facilitates the user's ability to match cosmetics, and which facilitates the storage and management of multiple cosmetic products.

### SUMMARY OF INVENTION

The cosmetic packaging system of the current invention utilizes a cap with a first side and an opposite second side. On the first side of the cap there is preferably an applicator that is configured for applying a first cosmetic. Preferably, the applicator is an elongated brush applicator configured for applying a liquid or semi-liquid cosmetic. Alternatively, the applicator is a sponge applicator or any other applicator suitable for applying the liquid or semi-liquid cosmetic.

On the opposite second side of the cap there is a holder and/or dispenser configured for holding and for dispensing a second cosmetic. Preferably, the holder is configured for holding a solid or semi-solid cosmetic and dispensing the cosmetic therefrom.

According to a preferred embodiment of the current invention, the applicator is configured to apply nail polish and the holder is configured to hold and dispense lipstick. Accordingly, the lipstick dispenser preferably has a containing means for concealing and storing the lipstick. The containing means can have a dispenser housing and a means to extend lipstick from and retract lipstick within the dispenser housing. In accordance with this embodiment, the lipstick is preferably dispensable through a top portion of the holder, the cap is coupled to the bottom portion of the holder and the applicator extends therefrom. The bottom portion of the holder or the cap can be configured with a securing means to detachable secure to a container for holding the nail polish. Accordingly, when the applicator is couple to the container for holding nail polish, the container provides a utilitarian function of a handle for applying the lipstick. Likewise, when the lipstick is contained within the holder or covered within the holder and the holder provides the utilitarian function of a handle for applying the nail polish.

According to one embodiment the dispenser housing is a cylinder, wherein lipstick is capable of being extended from and retracted within the cylinder by twisting the cylinder relative to the cap portion in a direction around its cylindrical axis. Alternatively, the dispenser housing has any shape and has a vertical adjuster, wherein the lipstick body is capable of being extended from and retracted within the dispenser housing by sliding the vertical adjuster up and down along the housing.

The holder can include a cover that securely covers the holder or a portion thereof. Where the holder is a lipstick dispenser, the cover preferably goes over the dispenser housing and is securable to the dispenser, the cap portion or a combination thereof. Preferably, the cover is securable to the dispenser, the cap portion or a combination thereof via snap features with the first snap feature on the cover and a second complementary snap feature on the dispenser, the cap portion or a combination thereof. The cover preferably secures to the holder and/or the applicator, such that the cover can be grasped and used to remove the applicator from a container for holding nail polish.

The applicator portion and the holder or dispenser portion are an integral single unit configured to be inseparable or, alternatively, are configured detachably coupled. Accordingly, the applicator portion and the holder are coupled through a securing means, which is complementary with the securing means for coupling the cap to the container for holding a liquid or semi-liquid cosmetic. For example, where the cap portion caps a nail polish bottle through a twist top securing means, the securing means for coupling the applicator portion and the holder portion is configured to remain secure while twisting the cap and the bottle relative to each other from the holder or dispenser portion. Accordingly, the securing means can comprise one or more vertical groves that fit over one or more complementary vertical ridges on the cap portion of the applicator portion. Alternatively, the securing means comprises a groove feature or channel on the cap or holder portion for receiving complementary slide features on the other of the cap or holder, as described in detail below.

Where the applicator and the holder capable of being separated, the applicator portion and the holder portion preferably have an identification means to quickly match the applicator portion with the holder portion after they are separated. The identification means are marks, shapes, color features or any combination thereof on the applicator portion and holder portion for matching the applicator portion and the holder portion after they are separated. Preferably, the identification means also provides the user with information regarding the cosmetics, the color of the cosmetic and or the comparability of the cosmetics dispensed from the holder portion and/or applied with the applicator portion. The identification means can uniquely match cosmetic products and/or allows the user to make reasonable choices of which cosmetic products to use together. For example, the applicator portion can be provided with triangle indicia identifying or coding the applicator portion for use with green nail polish. Accordingly, only a holder portion or holder portions configured for dispensing lipsticks that are compatible (or color coordinated) with green nail polish are also marked with triangle indicia.

In operation the cap portion caps a bottle of nail polish with the nail polish applicator protruding into the bottle of nail polish. The cap is capped to the bottle of nail polish by any suitable means, but is preferably capped through a twist-top mechanism, wherein the cap and the bottle are equipped with complimentary twist threads and the cap and the bottle securely engaged by twisting. With the nail polish bottle capped, the lipstick holder or dispenser can be uncovered and/or lipstick can be exposed such that the lipstick can be applied to the user's lips. The lipstick can then be covered and/or concealed within the dispenser and the applicator removed form the bottle to apply nail polish to the user's nails. Alternatively, the nail polish is applied first and the lipstick second. Regardless of the order of use, it is preferable that the bottle of nail polish provides a convenient handle for applying lipstick and the lipstick holder provides a convenient handle for applying nail polish.

### BRIEF DESCRIPTION OF THE FIGURES

FIG. 1 shows a cosmetic system with a nail polish bottle and a lipstick holder, in accordance with the instant invention.

FIG. 2a shows cosmetic system with a detachably coupled lipstick holder and nail polish applicator, in accordance with the instant invention.

FIGS. 2b-c illustrates a mechanism for detachably coupling the cosmetic applicator and the cosmetic holder or dispenser, in accordance with the instant invention.

FIG. 3 illustrates a cover with a snap feature for securely covering a lipstick dispenser utilizing complementary snap feature.

FIG. 4 illustrates a cosmetic system comprising a lipstick dispenser with a dispenser housing for concealing and protecting the lipstick body and an applicator attached thereto, in accordance with the current invention.

FIG. 5 illustrates a cosmetic system comprising a lipstick dispenser with a vertical adjuster for dispensing lipstick and an applicator attached thereto, in accordance with the current invention.

### DETAILED DESCRIPTION OF THE PREFERRED EMBODIMENTS

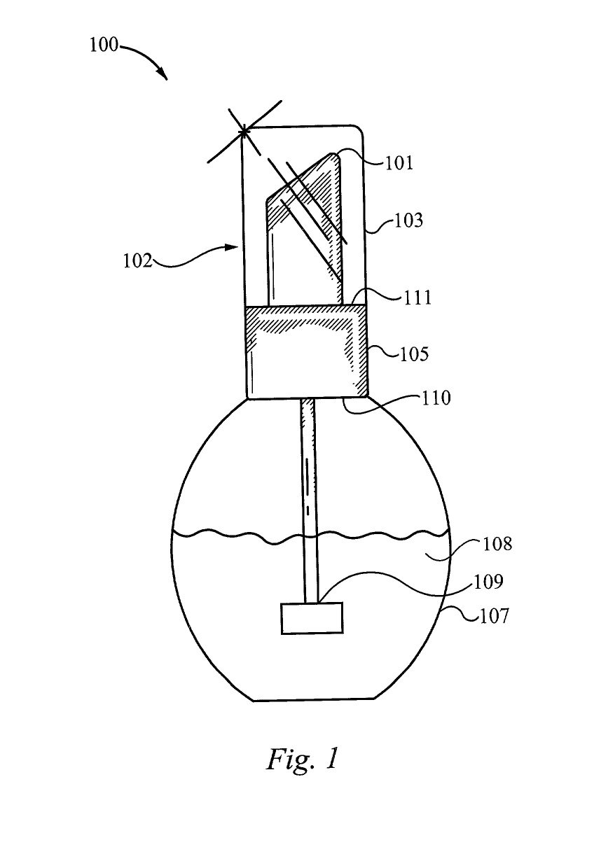

FIG. 1 shows a cosmetic system 100 in accordance with the instant invention. The system has a cap 105 with a first side 110 and a second opposite second side 111. Coupled to the first side 110 of the cap 105 is an applicator 109. Preferably, the applicator 109 is a brush applicator, a sponge applicator any other suitable applicator that is configured to insert into a bottle 107 with the bottle capped by the cap 105, as shown. Preferably, the cap 105 is configured to couple to the bottle 107 for holding a liquid or semi-liquid cosmetic 108, such as nail polish, and the second opposite second side 111 of the cap 105 is configured to couple to holder 102 for holding a solid or semi-solid cosmetic, such as lipstick.

The cap 105 is configured to detachably couple to the bottle 107 by any means known in the art, such as pressure seals or snap features. Preferably, the cap 105 detachably couples the bottle 107 through twist threads, wherein the bottle 107 and the cap 105 have complimentary twist threads that couple the cap 105 and bottle 107 by twisting the cap 105 and/or the bottle 107 in an opposite directions relative to each other.

A holder 102 on the opposite second side of the cap 105 is preferably configured to hold a lipstick body 101 and dispense lipstick therefrom while the cap 105 is couple to the bottle 107, as shown in FIG. 1. Preferably, the holder 102 has a removable cover 103. The removable cover 103 is preferable detachably secured to the cap 105 by snap features, threads or other suitable means.

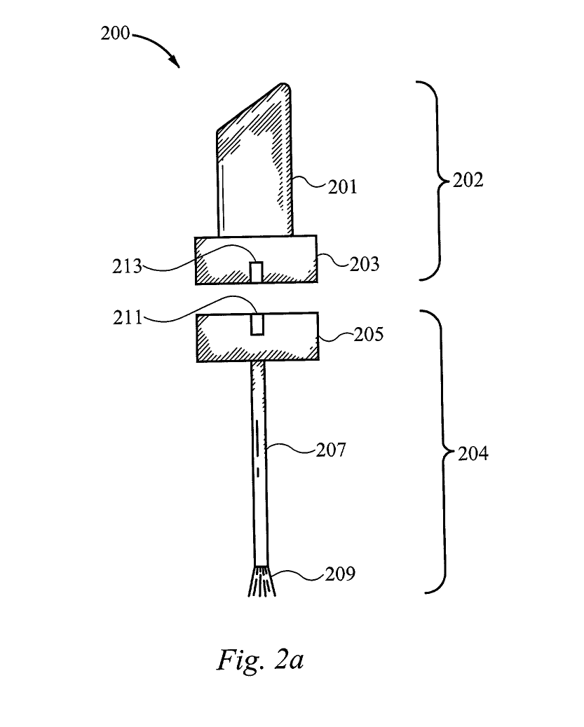

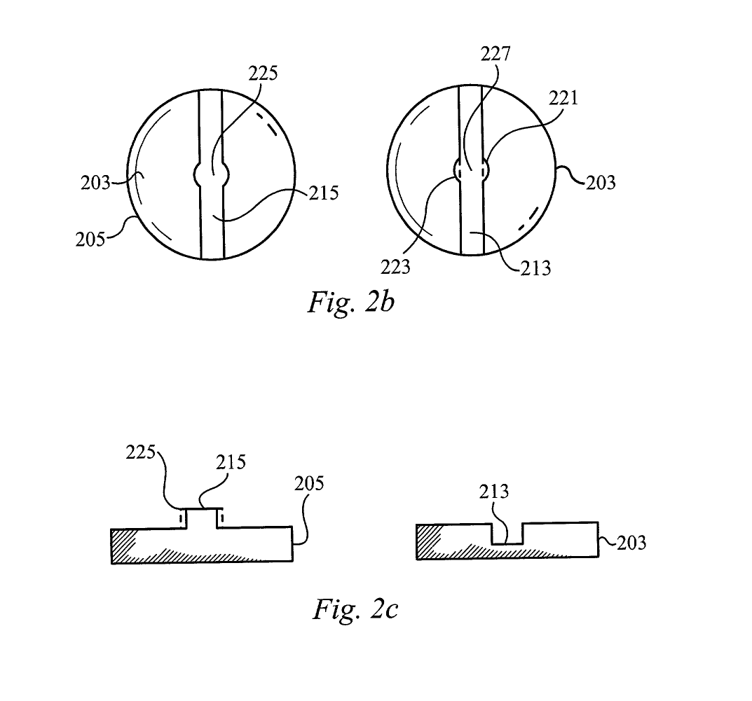

FIG. 2a shows cosmetic system 200 in accordance with an alternative embodiment of the instant invention. The system 200 has a holder 202 and an applicator 204, that is preferably configured for holding lipstick and applying nail polish, respectively. The holder 202 and the applicator 204 are configured to detachable couple. Accordingly, the holder 202 can be removed and used without the applicator 204. Preferably the holder 202 and the applicator 204 are coupled through a securing means which is compatible with the securing means for coupling the applicator 204 to a container (not shown) for holding the liquid or semi-liquid cosmetic, such the each securing mean is independently operable.

Still referring to FIG. 2a, the lipstick holder 202 has a support base 203 for supporting and holding a cosmetic body 201. Preferably, the holder has a cover or containing means, such as described above and below, respectively, to help protect the lipstick body 201. The applicator 204 has a cap 205 with an elongated body 207 extending from the bottom of the cap 205. Preferably, the elongated body 207 comprises a brush section 209 at its end for dispensing and applying the liquid or semi-liquid cosmetic from the container. Alternatively, the elongated body 207 comprises a sponge section 209 at its end for dispensing and applying the liquid or semi-liquid cosmetic from the container. It will be clear to one of ordinary skill in the art the applicator 204 can have any number applicator sections and configurations suitable for dispensing and applying a liquid or a semi-liquid cosmetic form the container. The cap portion 205 of the applicator 204 is configured to detachable couple to the container for holding the liquid or semi-liquid cosmetic, such as described previously.

Preferably the holder portion 202 and the applicator portion 204 are each provided with an identification means 213/211, which allows the holder portion 202 and the applicator portion 204 to be ready matched to each other once they are separated. The identification means 213/211 is any identification means including color-coded markers, indicia, shapes and symbols and can be configured to code the holder portion 202 and the applicator portion 204 for colors and/or types of cosmetics packages by the system 200.

FIGS. 2b-c illustrates a securing means for detachably coupling a cosmetic applicator and a cosmetic holder together, in accordance with the instant invention. The top of the cap 205 is configured with a raised slide feature 215. The support base 203 is configured with a complimentary grooved slide feature 213. As illustrated in FIG. 2c, the raised slide feature 215 has an enlarged center portion 225. The complimentary grooved slide feature 213 on the bottom of the base support 203 has an enlarged center-receiving portion 227. In operation, the raised slide feature 215 and the grooved slide feature 213 are aligned and the raised slide feature 215 is inserted into the channel of the grooved slide feature 213 until the enlarged center portions 225 and 221 eclipse. The grooved slide feature 213 preferably has securing edges 221 and 223 that helps secure the raised slide feature 215 within the channel of the grooved slide feature 213. Any number of securing means for attaching the cap 205 and the support base 203 are considered to be within the scope of the invention. For example, alternative securing means include, but are not limited to, two-part twist feature, snap features and other mechanisms for interlocking parts that are know in the art.

It is preferred that the securing means for detachably coupling the applicator portion and a holder portion is compatible with the securing means for detachable coupling the cosmetic applicator with the container for holding the liquid or semi-liquid cosmetics such that both of the securing means are independently operable and whereby that the securing means for coupling the applicator portion to the container can be engaged and disengaged with the holder potion serving as a handle.

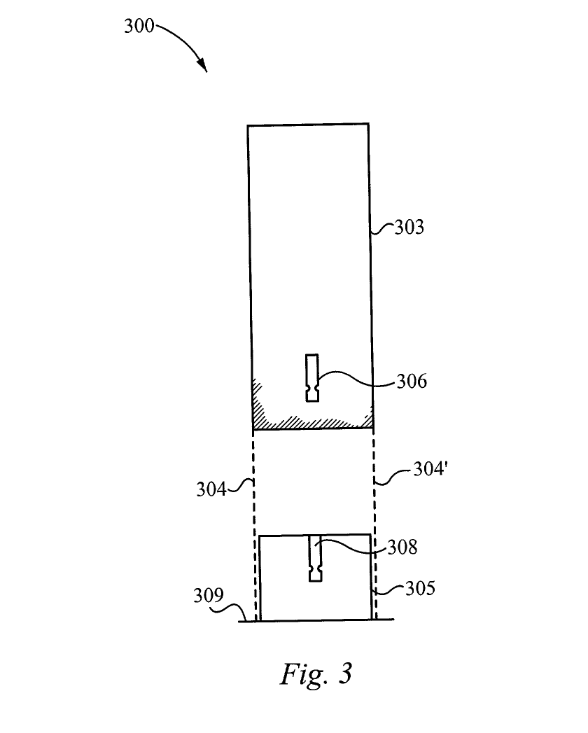

FIG. 3 illustrates a containing means 300 for covering and protecting a solid or semi-solid cosmetic body (not shown). The containing 300 means has a cover 303. The cover 303 has a first portion of a two-part pressure snap feature 306, which is either a protrusion or a groove. A support base 305 has the second complimentary portion of the two-part pressure snap feature 308. In operation the cap is placed over the support base 305, as indicated by the dotted lines 304′ and 304′, to the end of the support base 309 or until the snap features 306 and 308 are aligned and engaged. The support base 305 is couple an applicator, directly, or through a cap features, as described previously, wherein a user can remove an applicator (not shown) from the container for holding a liquid or semi-liquid cosmetic using the containing means 300 as a handle.

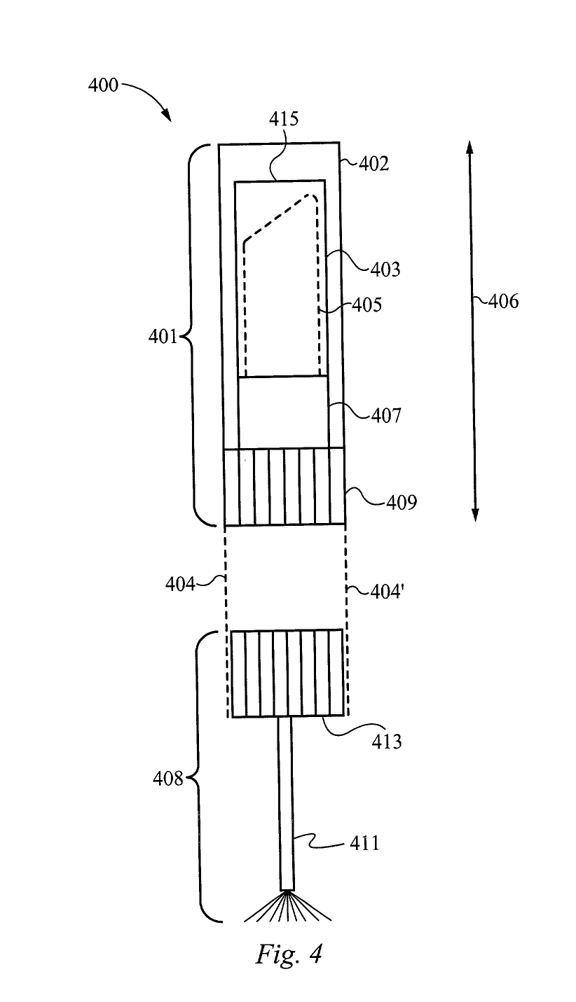

FIG. 4 illustrates a cosmetic system 400 with a dispenser portion 401 for concealing and protecting a lipstick body 405, which is configured to detachably couple to an applicator portion 408. The dispenser portion 401 has a support base 409. The support base 409 can be configured to fit over a cap portion 413 of the applicator portion 413 and secure to the cap portion 413 such as to allow the cap portion 413 to be removed from a bottle (not shown) by twisting the support base 409 through the dispenser portion 401. Accordingly, the base 409 and the cap portion 413 are configured one or more sets of complimentary groves or other features that help secure the dispenser portion 401 and the cap 413 together. Alternatively, the base 409 of the dispenser portion 401 functions directly as a cap to cap a container for holding nail polish and the applicator 411 is coupled to the base 409, such that the dispenser portion 401 and the applicator portion 411 are a single unit and not intended to be separated during use.

Still referring to FIG. 4, the dispenser portion 401 has a dispenser housing 403 that is preferably a cylinder. Within the dispenser housing 403, there is a twist features 407 that raises and lowers the lipstick body 405 in and out of the housing 403 by twisting the housing 403 relative base 409 in a direction around the axis 406. In use, the base 409 and the housing 403 are twisted relative to each other to retract the lipstick body 405 within the housing 403 and to extend lipstick body 403 from the top portion 415 of the housing 403.

Still referring to FIG. 4, the system 400 preferably has a cover 402 that detachably and securely couples to the support base 409, cap 413 or combination thereof, as previously described, providing additional protection for the lipstick body 405.

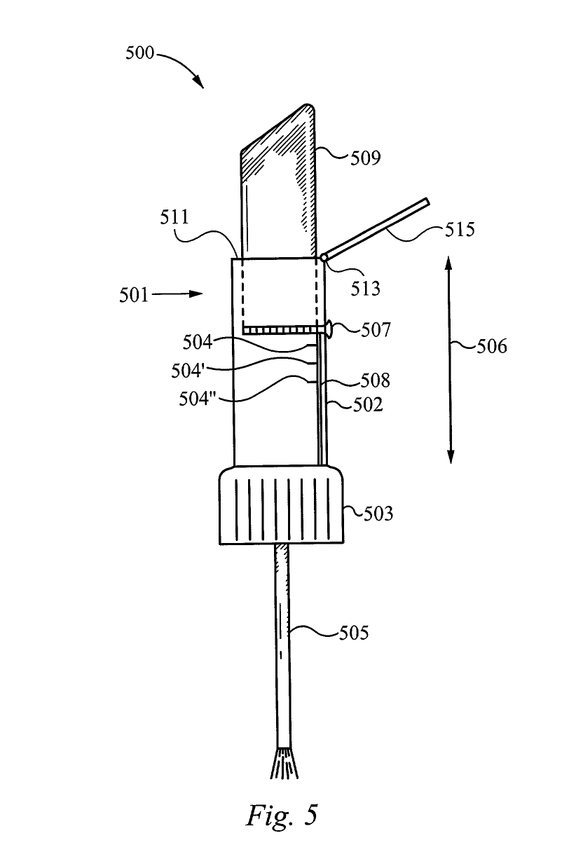

FIG. 5 illustrates an alternative system 500 with a holding or dispensing means 501 and an applicator 505 attached thereto, in accordance with the instant invention. The dispensing means 501 has a dispenser housing 502, which can be any shape. The dispenser housing 502 is coupled to an applicator 505 through a cap portion 503, which can be integral with the cap portion 503 and the dispensing means 501. The dispenser housing 502 has a vertical adjuster 507 that is coupled to a lipstick body 509. In operation, the vertical adjuster 507 is moved up along the axis 506 to extend the lipstick body 509 from the top portion 511 of the housing 502, as shown, whereby lipstick 509 can be applied or dispensed onto a user lips. In order to retract and store the lipstick body 509 within the housing 502, the vertical adjuster 507 is moved down along the axis 506. The vertical slot 508 is preferably configured with predetermined stops 504, 504′ and 504″ to secure the vertical adjuster 507 and the lipstick body 509 in a preferred position during use. The system 500, can also have a lid 515 that is attached through a hinge 513 to the dispenser housing 502. Alternatively, or in addition to the lid 515, the system 500 can have a fit over cap which secures to the dispensing means, such as previously described previously.

The current invention provides a package which logically links compatible cosmetics either by physically coupling the cosmetics in a single unified package or by providing identification of compatible cosmetics on portions or parts of an integratable cosmetic package, wherein the packaging can help consumers choose which cosmetics are best used with each other. The current invention is particularly well suited for packaging a nail polish with a compatible lipstick, wherein the lipstick is dispensable from the handle of an applicator for applying the nail polish. The packaging system of the instant invention allows manufacturers to portion cosmetics, such that under normal usage the compatible cosmetics are used up at approximately the same time. Further, the packaging system of the instant invention also allows manufacturers or provide manufactures with a unique packaging to entice consumers to try complementary cosmetics.

The above description and Figures are directed towards the preferred embodiments of the current invention. It will be clear to one skilled in the art that there are several alternative embodiments that are within the scope of the invention. For example, the cosmetic system can be configured for packaging any number of cosmetics. Further, the system can be configured to apply, store or dispense other cosmetic products including mascara, lip glosses, lip liners, rouge or any other cosmetic product that is preferential coupled with another cosmetic. Further, it is not required that the one of the cosmetics is solid or that one of the cosmetics is liquid; both or all of the cosmetics can be liquid or solid. Therefore, the scope of the invention should be interpreted by the following claims and their legal equivalents.

What is claimed is:

1. A cosmetic system comprising:
a) a cap with a first side and an opposite second side;
b) an applicator coupled to the first side of the cap for applying a first cosmetic; and
c) a dispenser coupled to the opposite second side of the cap for holding and dispensing a second cosmetic while coupled to the first side of the cap.

2. The cosmetic system of claim 1, wherein the dispenser is a lipstick dispenser.

3. The cosmetic system of claim 2, wherein the lipstick dispenser comprises a dispenser housing, wherein a lipstick body is capable of being extended from and retracted within the dispenser housing.

4. The cosmetic system of claim 3, wherein the dispenser housing is a cylindrical dispenser housing, wherein lipstick is capable of being extended from and retracted within the cylindrical dispenser housing by twisting the dispenser housing relative to the cap along its cylindrical axis.

5. The cosmetic system of claim 3, wherein the dispenser housing is an elongated dispenser housing and the lipstick is capable of being extended from and retracted within the dispenser housing by sliding a vertical adjuster couple to the lipstick up and down along the dispenser housing.

6. The cosmetic system of claim 1, further comprises a cover for covering the second cosmetic.

7. The cosmetic system of claim 6, wherein the cover comprises a securing means for securing the cover to the dispenser.

8. The cosmetic system of claim 7, wherein the securing means comprises a two-part snap feature with the first part of the two-part snap feature is on the cover and the second part of the two-part snap feature on the dispenser.

9. The cosmetic system of claim 1, wherein the applicator is an elongated brush applicator.

10. The cosmetic system of claim 1, further comprising liquid container with a dispensing orifice for holding and dispensing the first cosmetic, wherein the cap portion is configure to removably cap the dispensing orifice of the liquid container with the applicator positioned within the liquid container.

11. A system comprising:
a) a first container configured for holding a first cosmetic; and
b) a second container with a top portion and a bottom portion, the second container being configured for holding and dispensing a second cosmetic from the top portion and capping the orifice of the first container with the bottom portion.

12. The system of claim 11, further comprising an elongated applicator protruding from the bottom portion of the second container such that the applicator is inserted through the orifice of the first container with the first container capped by with the second container.

13. The system of claim 12, wherein the elongated applicator comprises a brush section.

14. The system of claim 11, wherein the second container comprises a lipstick dispenser.

15. The system of claim 14, wherein the lipstick dispenser comprises an elongated dispenser housing and a means for extending the lipstick form and retracting the lipstick into the dispenser housing.

16. The system of claim 15, wherein the means for extending the lipstick form and retracting the lipstick into the elongated dispenser housing is actuated by twisting the elongated dispenser housing.

17. The system of claim 15, wherein the means for extending the lipstick form and retracting the lipstick into the elongated dispenser housing comprises vertical adjuster couple to the lipstick.

18. The system of claim 11, further comprises a cover for covering a portion of the second container.

19. The system of claim 18, wherein the cover comprises a securing means for securing the cover over the second container.

20. The system of claim 19, wherein the securing means comprises a two-part snap feature with the first part of the two-part snap feature on the cover and the second part of the two-part snap feature on the second container.

21. A cosmetic system comprising:
a) a cap section with a top and a bottom, the cap section comprising a nail polish applicator protruding from the bottom of the cap section, the cap section being configured to removably coupled a container with a the nail polish applicator protruding into the container; and
b) a lipstick dispenser with a top portion and a bottom portion, wherein the lipstick dispenser is configured to dispense lipstick through its top portion while coupled to the portion of the cap through its bottom portion.

22. The cosmetic system of claim 21, wherein the lipstick dispenser is removably couples to the top portion of the cap.

23. The cosmetic system of claim 21, wherein the cap and the lipstick container have identification to match the lipstick container with the cap.

24. The cosmetic system comprising:
a) a first container being configured for holding a liquid cosmetic;
b) a second container comprising an applicator for dispensing the liquid cosmetic from the first container, the second container being configured for holding and dispense solid cosmetic; and
c) coupling means for coupling the second and first container, whereby the first container is coupled to the second container while dispensing the solid cosmetic.

25. A lipstick dispenser comprising:
a) means for dispensing lipstick for dispensing lipstick form a first end of the lipstick dispenser; and
b) a cap section for capping a cosmetic container with a second end of the lipstick dispenser.

26. The lipstick dispenser of claim 25, further comprising an applicator for dispensing the cosmetic form the container.
